(19) United States
(12) Patent Application Publication
(10) Pub. No.: US 2022/0308547 A1
(43) Pub. Date: Sep. 29, 2022

(54) REMOTE CONTROL SYSTEM FOR VIBRATING SUPPLYING DEVICES

(71) Applicant: BROVIND VIBRATORI S.P.A., Cortemilia (IT)

(72) Inventor: Paolo REOLFI, Cortemilia (IT)

(73) Assignee: BROVIND VIBRATORI S.P.A., Cortemilia (IT)

(21) Appl. No.: 17/616,938

(22) PCT Filed: Jun. 3, 2020
(86) PCT No.: PCT/IT2020/050140

§ 371 Date: Dec. 6, 2021

(30) Foreign Application Priority Data
Jun. 18, 2019 (IT) 102019000009351

(51) Int. Cl. G05B 19/05

(52) U.S. Cl. CPC G05B 19/052; G05B 19/054; G05B 2219/1214; G05B 2219/1215

(57) ABSTRACT

A remote control system for vibrating supplying devices is described, comprising electromagnetic power means driven to vibrate in frequency at least one element of a power supply through a control device (CONTROL_ETH, CONTROL_ETH_IoT), with fixed or multiple channels, with fixed or variable frequency, the control device (CONTROL_ETH, CONTROL_ETH_IoT) being designed to be directly interfaced with a central server, the control device (CONTROL_ETH, CONTROL_ETH_IoT) being in parallel directly connected to a network supervisor(PLC), such as a PLC or Industrial PC, for its operating aspects, and/or to a secondary server(SERVER) to acquire a history of parameters, on an industrial Ethernet network (ETH).

The present invention refers to a remote control system for vibrating supplying devices.

In general, the present invention refers to applications of devices to generate or transmit jigging movements with means for controlling direction, frequency or width of vibrations or shaking movements, jigging transporters comprising helical channels or a coil or ducts for lifting materials, motors with magnets, oscillators or oscillating vibration, inductance or coil systems, or electromagnetic devices.

In particular, the present invention refers to a program control different from the numeric control, namely in sequence controllers or logic controllers which use digital processors, to arrangements for transmitting signals characterized by the user of a wireless electric connection through a radio connection, to system for transmitting non-electric signals, for example optical systems which use light waves, for example Infrared or HVAC, to remote control systems which use repeaters, converters, gateways, to the transmission or reception of remote control signals through a network, to a remote control using other portable devices, for example cellular phone, PDA, laptop, to the total factory control, namely a centralized control of a plurality of machines, for example direct or distributed numeric control [DNC], flexible manufacturing systems [FMS], integrated manufacturing systems [IMS], computer integrated manufacturing[CIM] characterized by the transport system, to control devices, for example for safety, warning or correction of failures, to systems controlled by an electric computer, to methods or arrangements to detect recording media, for example to read electromagnetic radiation diagrams, for example optical detection, through a corpuscular radiation through radiations which use wavelengths greater than 0.1 mm, for example radio waves or microwaves, the querying device being adapted for various applications, and barcodes.

Following the consolidation of specifications related to industrial communication protocols linked to “Industria 4.0” project and their disclosure, the different market sectors related to automation have received and included such technologies, spreading their use in all aspects linked to manufacturing, especially in monitoring, servicing and accumulating data for statistics and planning.

While the most historically and technologically advanced sectors have quickly reacted to the introduction of these new technologies in their products, the sector of manufacturers of vibrating supplying systems has not deemed to purchase new products aligned to such specifications, since the supply system is traditionally perceived as a subordinate appendix of an automatic assembly line, thereby assigning to the PLC on board the machine the task of smart communication with the rest of the “Industria 4.0” system.

However, this in time has created a meaningful gap in the collection of data coming from the manufacturing assembly lines, resulting in the impossibility of analyzing the performances of vibrating supply systems in order to perform preventive maintenance or verify the line performances in terms of micro manufacturing interruptions, namely economic losses due to potential stops of the automatic line.

Therefore, following the experience created in the field and the feedback obtained from customers by the Applicant of the present application, a series of electronic control devices have been made, capable of directly communicating with the rest of a line equipped with protocols compatible with “Industria 4.0” without having to necessarily pass from a PLC system or equivalent to convert and store data.

Studies for making a series of electronic control devices with Ethernet-based communication protocols were made since 2009, with first prototypes of double-channel electronic control devices equipped with additional proprietary card.

In the 2015's, a prototype was made for a series of independent four-channel electronic control devices with interchangeable commercial communication card capable of being directly interfaced with an “Industria 4.0” communication and control line.

Herein below, a series of advantages and consequently problems solved by a similar approach are described.

Conformity to IoT protocol: the development of an architecture of the control device capable of housing the most common interchangeable commercial cards, such as, for example, HMS Anybus CompactCOM, allows also accommodating the models compatible with the Industrial Internet of Things, by interfacing the control device with the devices responsible for collecting data in parallel with the operating connection with the PLC on board the machine without interfering with these manufacturing processes; the collection of operating data of the control device by exploiting only the connection to the PLC is an ad hoc operation to be automatically programmed through a command line sent to the PLC non-cyclically, with respect to the normal manufacturing operation. However, in this way, the command and communication line is engaged for the time useful for the cyclic communication of all control devices and for downloading information send to a central collecting server. Instead, through a IoT device, this operation can be performed in parallel by the control device sending its own data to a central collecting server, going on in parallel to work connected to the PLC.

Interchangeability as regards the communication protocol: the specific choice of housing devices known at commercial level in place of proprietary cards allows to change in real time the communication protocol without having to re-adapt or set the control device.

Taking as reference a procedure already used in other fields of the electronic control, for example, inverters for electric motors, the communication chances offered by an “Industria 4.0” protocol are extended to the automatic loading of operating parameters, in case of replacement of a control device with a new one, not previously parametrized; in fact, it is possible to set the control device in order to periodically send its own operating parameters continuously updated, for example, in case of revision by part of a maintenance operator, to a master unit, PLC or server. The same family of control devices is arranged for receiving such parameters after a query to the master in case of insertion in the line without previous parametrization. Such control device, in fact, can communicate its own presence to the master, requiring its own operating parameters to be able to operate similarly to the previous, newly replaced control device. Such univocal parameters would be guaranteed by the use of the same IP address on the line of the previous control device.

US-A1-2002/0072809 deals with a control system of the operation of a machine comprising a plurality of devices, said control system comprising a control program to supervise and acquire data (SCADA) comprising a plurality of program blocks and a plurality of database blocks, a supplementary program, a processor adapted to execute the SCADA program, a memory coupled with the processor to store the SCADA program and the supplementary program, an input/output device coupled with the processor, to receive and supply electric signals directly to and from the devices. The processor is adapted to execute the supplementary program and to control the operation of the devices. The supplementary program allows the processor to inter-operate at least one program block of the SCADA program and at least one database block of the SCADA program, in reply to electric signals received from the devices, so that the processor can directly control the devices and without the need of an additional external control device.

US-B2-9,413,607 deals with a system, a method and a software product for updating parameters, such as the requested packet intervals RPI, in a network. The system can include one or more PLC, communication control devices and I/O devices coupled in a communication network, such as EtherNet/IP. A request of modification of a parameter, for example Scanning speed or Timeout value, is transmitted by the PLC to a I/O device which specifies a new parameter value or a timeout value. The I/O device can receive the message, use a temporary timeout value when processing the message and transmit a confirmation, confirming the new value to the PLC. The I/O device can use the updated parameter and the new timeout value. The updated parameter can be implemented without the need of removing and re-establishing the network connections to the affected devices.

US-A1-2002/0072809 refers to a supervising system of an automatic plant without disclosing parameters of electromagnetic actuations.

US-B2-9,413,607 refers to real time updates of communication parameters in a network without dealing with a use of the network to exchange working operating parameters between a control device and a supervisor, such as for example a PLC or Industrial PC.

Operating data of a control device are collected only by exploiting the connection to a PLC through conventional networks, such as, for example, I/O, serial RS232. The connection to the PLC must be programmed to be able to engage the command and communication line for the time useful for polling all possible control devices on the line itself and for downloading information to send to a central collecting server, automatically through a command line to be sent to the PLC non-cyclically with respect to the normal manufacturing operation.

The problem is solved by inserting a control device for vibrating supplying devices in a network to allow a direct communication, by means of ad hoc commercial communication cards, directly integrated on the motherboard, without thereby having to pass through external devices for switching the protocol. The control device taken at the same level of the other devices in the network allows the direct communication on the same channels without passing through converters and without processing ad hoc code lines.

Object of the present invention is solving the above prior art problems by providing a diagnostics system to be able to remotely display and possibly act on the parameters, to perform saving and loading operations for the operating parameters, in real time, in the field of vibrating supplying devices.

A further object is being able to remotely perform a firmware update through access to the network of which the control device is part, from any suitable device, for example, from PC, tablet, smartphone, etc.

A further object is having available a control device to simultaneously act in parallel as slave in the upper network of which it is part and as master of a sub-network, in which it communicates through a dedicate protocol, to drive small devices, such as, for example, solenoid valves.

A further object is providing a control device compatible with “Industria 4.0” specifications, and thereby communication in parallel with a storage server simultaneously with the function of slave in the network.

The above and other objects and advantages of the invention, as will appear from the following description, are obtained with a remote control system for vibrating supplying devices, as claimed in claim 1. Preferred embodiments and non-trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) can be made to what is described, without departing from the scope of the invention as included in the enclosed claims.

The present invention will be better described by some preferred embodiments thereof, provided as a non-limiting example, with reference to the enclosed drawings, in which:

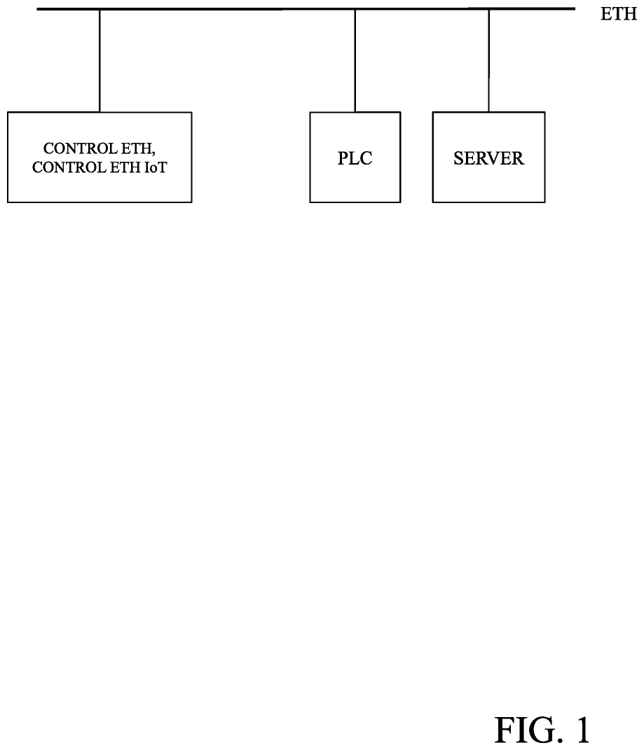

FIG. 1 shows a functional diagram of an embodiment of the remote control system for vibrating supplying devices according to the present invention;

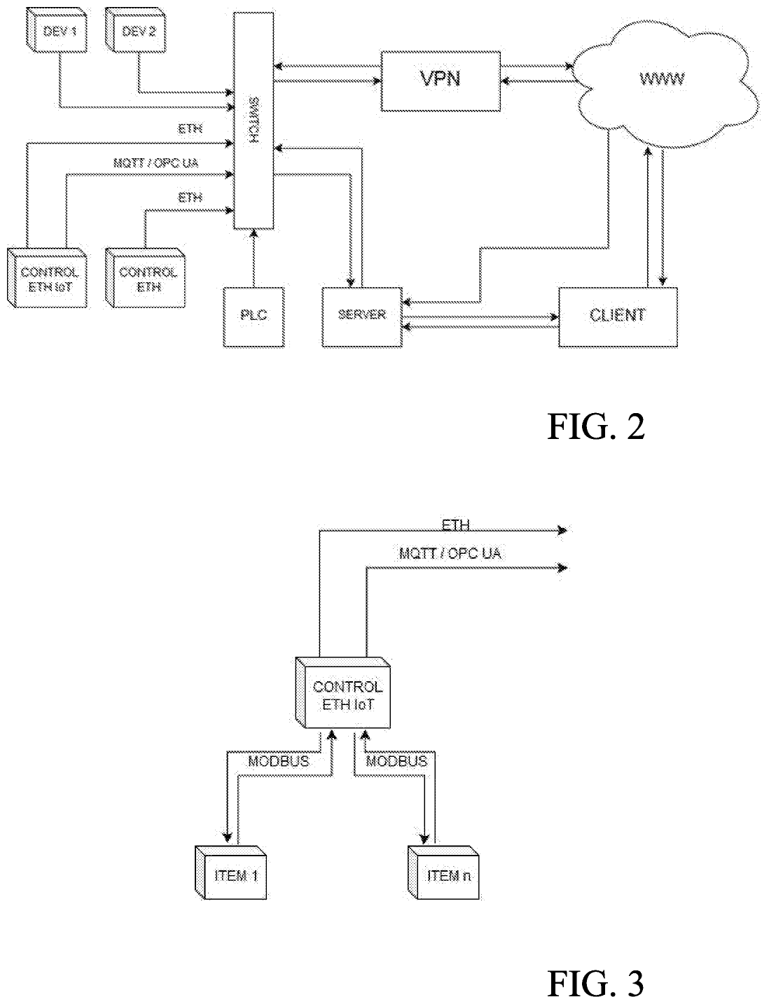

FIG. 2 and FIG. 3 show a functional diagram of a first and a second example embodiment of the remote control system for vibrating supplying devices according to the present invention; and

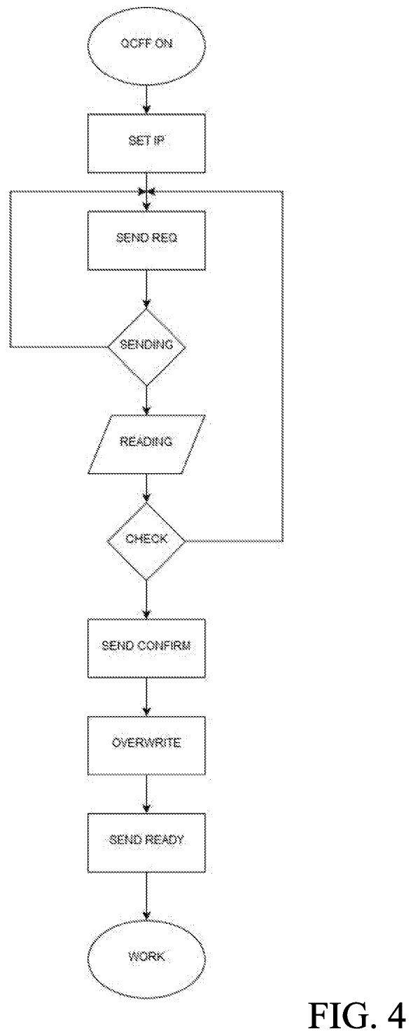

FIG. 4 shows an example for performing an automatic operating procedure of the remote control system for vibrating supplying devices according to the present invention.

With reference to FIG. 1, it is possible to note that a remote control system for vibrating supplying devices comprises electromagnetic power means driven to vibrate in frequency at least one element of a vibrating supplying device through a control device CONTROL ETH, CONTROL_ETH IoT, such control device CONTROL_ETH, CONTROL_ETH IoT being with fixed or multiple channels, with fixed or variable frequency.

Advantageously, the control device CONTROL_ETH, CONTROL_ETH IoT is designed to be directly interfaced with a central server, the control device CONTROL_ETH, CONTROL_ETH IoT being in parallel directly connected to a network supervisor PLC, such as a PLC or Industrial PC for the operating aspects, and/or to a secondary server SERVER to acquire a history of the parameters, on an industrial Ethernet network ETH.

The control system houses devices known at commercial level or proprietary communication cards, designed to change the communication protocol upon changing the above devices or the above cards without having to re-adapt or set the control device CONTROL_ETH, CONTROL_ETH IoT.

In particular, the control device CONTROL_ETH, CONTROL_ETH IoT is set in order to send its own, continuously updated operating parameters to the network supervisor PLC, and/or to the secondary server SERVER.

Moreover, the control device CONTROL_ETH, CONTROL_ETH IoT belongs to a family of control devices wherein each of such devices is designed to receive operating parameters after a query to the network supervisor PLC, and/or to the secondary server SERVER.

In fact, such control device CONTROL_ETH, CONTROL_ETH IoT is designed to communicate its own presence to the network supervisor PLC, and/or to the secondary server SERVER, requiring its own operating parameters to be able to operate similarly to a previous, newly replaced control device. Such univocal parameters would be guaranteed by the use of the same IP address on the Ethernet line ETH of a previous device.

The control device CONTROL_ETH, CONTROL_ETH IoT is capable of intervening in parallel as slave in an upper level network, and as master in a sub-network communicating through a dedicate protocol, to drive small devices, such as solenoid valves.

Preferably, the control system has a control device CONTROL_ETH, CONTROL_ETH IoT compatible with “Industria 4.0” specifications, in parallel with a storage server and having the function of a slave in the network.

### EXAMPLES

FIG. 2 shows, one of the many chances of inserting a control device equipped with Ethernet communication card in an automatic manufacturing line in compliance with “Industra 4.0” specifications.

SWITCH: device used in the most common network architectures to allow many connected devices to exchange data with supervisors (I.O. PLC, industrial PC, etc.) by suitable addressing the input/output data packets;

PLC: supervisor of the automatic line (manufacturing side) which deals with monitoring all devices so that they correctly execute the program assigned to the automatic line;

SERVER: information device (1.0. PC), single or cluster of information devices which can perform several tasks simultaneously, such as for example collecting historical data from all connected devices, sending recipes of instructions to be performed by the PLC, etc.;

CLIENT: device through which an operator can query the devices (1.0. PC, smartphone, tablet), for example to verify their parameters and/or modify them, update the firmware, remotely manage the line, passing through the server (company intranet) or from outside (internet);

WWW: network outside the manufacturing line (internet, cloud);

VPN: control system to manage the accesses from external network (internet) to internal company network (intranet);

DEV1, DEV2: possible other compatible devices (1.0. servomotors, inverters) which play their role in the automatic manufacturing line by communicating according to the pre-set protocol ETH;

ETH: industrial Ethernet communication protocol (I.O. Ethernet IP, Profinet, etc.) used for the connection of devices to the supervisor (I.O. PLC) in a company manufacturing network;

MQTT/OPC UA: two of the possible direct communication protocols between devices and server for the parallel communication, while the device performs its function supervised by PLC;

CONTROL_ETH: control device equipped with card for communicating on ETH protocol, chosen with the PLC but lacking the direct communication protocol MQTT/OPC UA with the server. In this case, it is possible to access the parameters of the control device, but only passing from PLC. Moreover, in the caso in which a storage of parameters has to be performed, it would not be continuous, but with non-cyclic instructions to be executed through an instruction given to the PLC outside the normal routine of the manufacturing line;

CONTROL_ETH IoT: control device equipped with card having both the communication protocol ETH for the operating connection to the automatic line, and the direct communication protocol MQTT/OPC UA with the server. In this way, while the control device performs its normal operating functions supervised by the PLC, it can, in parallel and without overlapping, communicate its own parameters upon request of the server on a second channel.

With reference to FIG. 2, an explicative diagram is shown for the double master/slave function which the control device can adopt.

ITEM 1 . . . n: elementary auxiliary device (I.E. solenoid valve, temperature sensor, etc.) compatible with the Ethernet communication;

MODBUS: possible communication protocol different from the one used on the automatic line through which the control device can manage/query the elementary devices autonomously without waiting for instructions from the PLC.

With reference to FIG. 4, an example is shown for performing the automatic procedure of assigning the parameters to a new control device as replacement of a previous one, whose parameters have been stored.
QCFF ON: turning-on the device not parametrized after insertion in the network;
SET IP: assignment of the IP address of the previous device;
SEND REQ: request to the supervisor (I.E. PLC) for receiving the parameters (in turn directly store on PLC or to be requested to the SERVER);
SENDING: receiving the parameters. If OK one proceeds, otherwise they are requested again, defining a fixed number of requests before a possible error status ERRORE;
READING: the control device reads the received parameters;
CHECK: the control device verifies the correctness of the received parameters. If OK it proceeds, otherwise it requests the parameters again, defining a fixed number of requests before a possible error status ERRORE;
SEND CONFIRM: sends a confirmation of correct parameters received to the supervisor;
OVERWRITE: internal procedure for over-writing the parameters;
SEND READY: sends a ready-to-work signal to the supervisor;
WORK: starts the regular activity of the parametrized control device.

1.-6. (canceled)

7. A remote control system for vibrating supplying devices, comprising electromagnetic power means driven to vibrate in frequency at least one element of a vibrating supplying device through a control device, the control device being with fixed or multiple channels, with fixed or variable frequency, the control device being designed to be directly interfaced with a central server, the control device being directly connected to a network supervisor, such as a PLC or Industrial PC, for its operating aspects, and/or to a secondary server to acquire a history of parameters, on an industrial Ethernet network.

8. The remote control system of claim 1, designed to set the control device in order to send its own operating parameters continuously updated to the network supervisor, and/or to the secondary server.

9. The remote control system of claim 1, wherein the control device belongs to a family of control devices wherein each device is designed to receive the parameters after a query to the network supervisor and/or to the secondary server.

10. The remote control system of claim 1, wherein the control device is designed to communicate its own presence to the network supervisor, and/or to the secondary server, requiring its own operating parameters to be able to operate similarly to a previous control device, newly replaced, using a same IP address on the Ethernet line.

11. The remote control system of claim 1, wherein the control device is designed to intervene in parallel as slave in an upper level network, and as master in a sub-network communicating through a dedicate protocol, to drive devices such as solenoid valves.
